(19) United States
(12) Patent Application Publication
(10) Pub. No.: US 2008/0003662 A1
(43) Pub. Date: Jan. 3, 2008

(54) Novel enzyme compositions for removing carbon dioxide from a mixed gas

(76) Inventor: Michael C. Trachtenberg, Lawrenceville, NJ (US)

Correspondence Address: Martin L. McGregor, 26415 Oak Ridge Drive, Spring, TX, 77380, US

(21) Appl. No.: 11/801,418

(22) Filed: May 9, 2007

Related U.S. Application Data
(60) Provisional application No. 60/798,845, filed on May 9, 2006.

(51) Int. Cl. B01D 53/84

(52) U.S. Cl. 435/266

(57) ABSTRACT

A process is disclosed for gas separation wherein carbon dioxide in a mixed gas stream is converted to bicarbonate by contacting a gamma carbonic anhydrase enzyme designated as CAM in the temperature range of 40 degrees to 85 degrees C. in an enzyme catalyzed carbon dioxide capture system.

### RELATED APPLICATION

This application is a continuation in part of co-pending provisional application Ser. No. 60/798,845 filed May 9, 2006.

### FIELD OF THE INVENTION

This invention relates to a process utilizing natural, modified or engineered enzymes as agents, alone or immobilized in conjunction with membranes or other techniques or cells or cell fragments for the extraction of one or more specific molecules from a mixture of molecules in a first gaseous phase and moving at least one specific molecule to a second phase. Specifically carbon dioxide is to be separated from a gas mixture, or a solution of mixed gases. The present invention relates to the extraction of carbon dioxide from the atmosphere or combustion source with an improved enzyme catalyst for conversion to bicarbonate. The process may also include the step of separating the carbon dioxide equivalent and its subsequent conversion to carbon dioxide in a concentration greater than the concentration of the source of extracted carbon dioxide.

### BACKGROUND OF THE INVENTION

Traditional means of isolating gases from a mixed stream involve physical or chemical reactions or a combination thereof, and inert semipermeable membranes. Among such processes are cryogenic, gas-liquid and gas-solid sorptive techniques (e.g. pressure swing adsorption, amine treatment, iron sponge, etc.), and immiscible liquid-liquid extraction (recently summaries see Michaels A S: New vistas for memebrane technology, Chemtech. 19:160-172,1989; and Babcock R E, Spillman R W, Goddin C S & Cooley T E: Natural gas cleanup: A comparison of membrane and amine treatment processes. Energy Prog. 8(3):135-142, 1988.) Newer technologies focus on the of inert semipermeable membranes but these do not offer a solution that is particularly unique over existing process (Spillman R W: Economics of gas separation membranes. Chem. Engr. Prog, 85:41-62, 1989). Membrane systems have been said never to achieve complete separation (Spillman, id. 1989). Prior art physical or chemical means do not readily allow segregation among gases with similiar physical or chemical properties or those in low concentrations. In general prior art does not effectively even with extracting gases or gas equivalents from a dissolved or ionized state to regenerate a purified gas. The prior art generally treats gases already dissolved in water such as carbon dioxide or oxygen in Bonaventura et al. U.S. Pat. Nos. 4,761,209 and 4,602,987 and carbon dioxide in Henley and Chang U.S. Pat. No. 3,910,780. No reference as been located in which the enzyme contacts a gas in gas stream, separates the gas and in a subsequent step regenerates a purified gas.

Traditional gas separation means commonly exhibit one or more of the following problems: they are energy inefficient, commonly nonspecific, quite slow, require a relatively pure feedstock, depend on a significant pressure head, or use ecologically questionable or toxic compounds. The relatively pure feedstock requirement may result in a geographical restriction of available feed materials. The geographic availability may require shipment from distant locations such that transportation costs may be high, and even prohibitive for some uses. The preceding limitations present restrictions on the growth and application of gas extraction/purification systems. A gas separation or enrichment process that did not require a concentrate feed-stocks thus eliminating or reducing transportation requirements would be beneficial.

In contrast to the disadvantages enumerated above for traditional physical/chemical methods, biological catalysts (enzymes) present several advantages including enhanced efficiency, speed, and increased specificity. Enzymes also commonly distinguish optical isomers. Further, they can be used at moderate temperatures and pressures, enhancing safety.

Prior use of enzymes as focused very largely on the food processing industry, cleansing or detergent applications, or processing of sewage. Industrial applications in the gas field have been limited. Prior application of enzymes to gas extraction are found in patents to Bonaventura et al, U.S. Pat. Nos. 4,761,209 and 4,602,987 and Henley and Chang U.S. Pat. No. 3,910,780. Bonaventura uses membranes impregnated with carbonic anhydrase to facilitate transport of CO2 across a membrane into water in an underwater rebreathing apparatus. Henley and Chang make a similar use of carbonic anhydrase. Both processes operate on dissolved carbon dioxide. Neither taught fixation of the enzyme with the active site exposed to gaseous phase with sufficient hydration to maintain a reactive conformation. Neither taught modification of DNA coding for enzymes to build a for fixation or enhanced catalysis. Indeed Bonaventura took for granted that the crude coupling techniques disclosed would deactivate a large fraction of the active enzyme. The Bonaventura patents contain computations showing that only a small fraction (1%) of the carbonic anhydrase need retain its activity in the bonded membrane to provide adequate capacity to remove carbon dioxide from the proposed apparatus in the illustrative uses. Henley and Chang to not discuss activity losses nor provide any discription of fixation techniques to enhance enzyme activity when in the active site is directly exposed to a nonaqueous environment.

Despite some significant advantages, a variety of major problems have limited the application of enzymes in industrial settings. These include short lifetime of either free or immobilized enzyme, fouling and biofouling, separation of the enzyme from the immobilization surface, limited availability of enzymes in sufficient quantity, and expense of manufacture.

These problems have resulted in relatively few efforts to use enzymes for manipulation of gases. Further, physical/chemical means are in place commercially; they are understood and represent established technology and significant investment.

Despite these historic considerations a number of recent developments now allow broad based enzymatic applications. First, the development of DNA libraries and the techniques needed to generate such libraries so that large amounts of enzyme in be made economically. Previously, and even today, many enzymes are derived by purification from biological source. Second, development of techniques to generate membrane expenses of enzymes and even direct secretion such that harvesting the enzymes is easier and economically feasible. Third, the development of new immobilization techniques which allow long lifetime and high efficiency.

The present invention also provides a means not previously available for concentrating a gas in an enzyme separation, that is expanding the useable range of the enzyme from aroung 40 degrees C. to about 85 degrees C.

### SUMMARY OF THE INVENTION

The invention provides a process for separation of carbon dioxide from a mixed gas stream wherein the gas stream is contacted by a specific carbonic anhydrase, designated herein as CAM, and carbon dioxide is removed from the gas stream, converted to bicarbonate in an aqueous solution, and optionally converted back to a gas stream which is substantially enriched on carbon dioxide. The invention is a process for gas separation wherein carbon dioxide in a mixed gas stream is converted to bicarbonate by contacting a carbonic anhydrase enzyme designated as CAM in the temperature range of 40 degrees to 85 degrees C. in an enzyme catalyzed carbon dioxide capture system.

### BRIEF DESCRIPTION OF THE DRAWINGS

FIG. 1 illustrates the Effect of Temperature on Carbon Dioxide Removal Normalized to BCA II.

FIG. 2 illustrates Effect of Temperature on Carbon Dioxide Removal in the Permate.

FIG. 3 illustrates Effect of Temperature on Carbon Dioxide Removal in the Rententate.

### DETAILED DESCRIPTION OF THE INVENTION

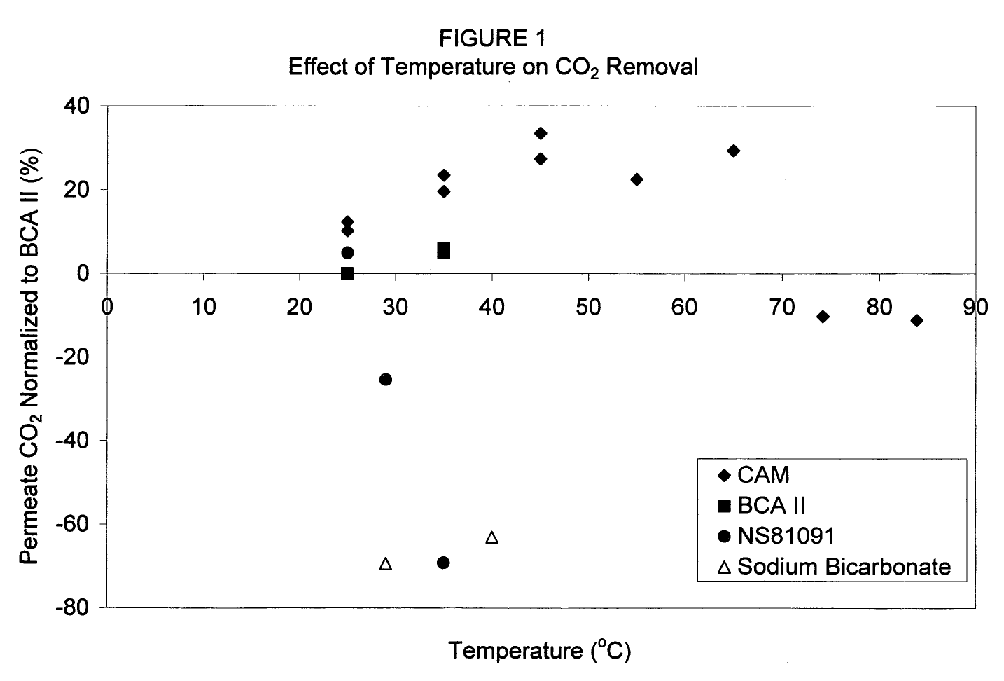

FIG. 1 illustrates experimental results for Carbon dioxide capture in a hollow fiber reactor normalized for comparison to bovine carbonic anhydrase II. As the data show, above about 40 degrees the only system still separating Carbon dioxide was the CAM isozyme system.

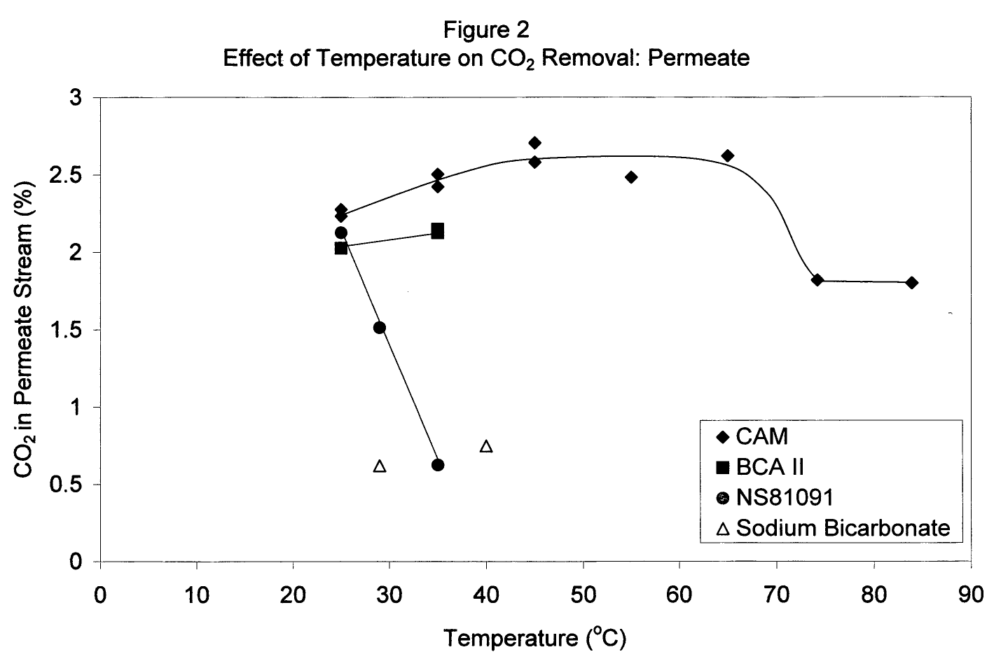

FIG. 2 shows data for the permeate stream of a typical contained liquid membrane reactor where the separation is catalyzed by the conventional catalysts and by the isozyme of the invention CAM.

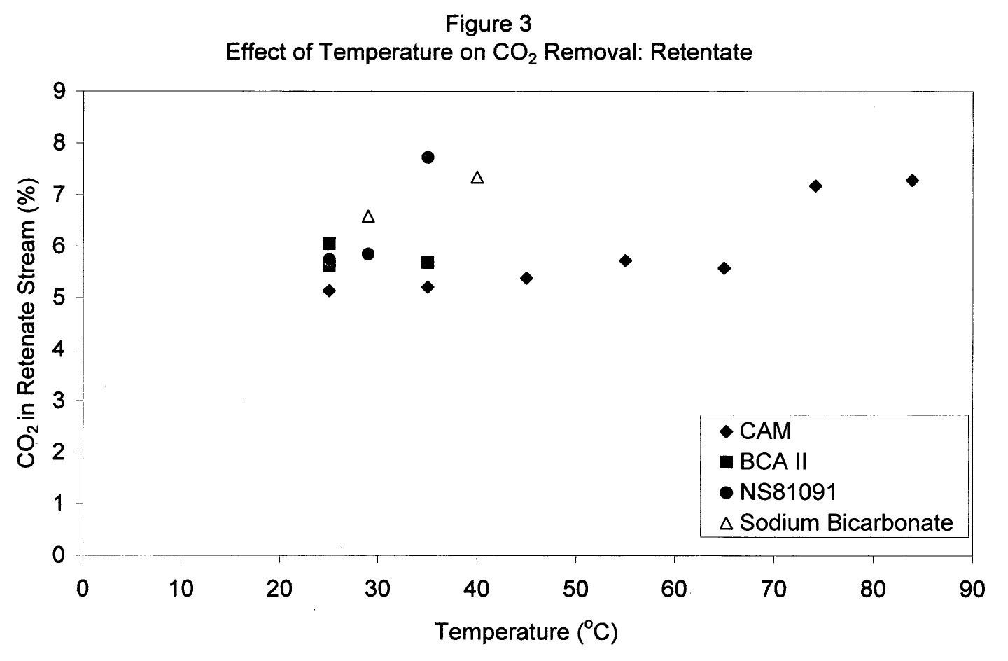

FIG. 3 shows data for the retentate stream of the same separation. Each data set clearly shows that the CAM enzyme is the only system operable in the range of 40 to 85 degrees C.

The inventive concept is to use thermophilic enzymes that can drive the engineering applications to new areas of use. Data shown in FIGS. 1 and 2 illustrate that other carbonic anhydrase isozymes are unsuited for certain separations as they denature due to the high operating temperature. In contrast the CAM isozyme continues to operate through 85° C. The consequence is that many outlet gas streams such as flue gases can be used directly without need for heat exchangers or other costly equipment or processes. Further, almost all other isozymes (catalysts) of this class cannot operate at all at these elevated temperatures. The CA II isozyme has an upper bound of 40° C. while the isozyme from bacillus is limited to 25° C. This high temperature isozyme, known as CAM and a member of the gamma family of carbonic anhydrases enables carbon dioxide gas capture technology not previously possible.

Any enzyme facilitated bio reactor can be used in the invention, the novel factor is the use of the surprisingly heat stable isozyme. The bioreactors of Trachtenberg disclosed in U.S. Pat. No. 6,143,556, the disclosure of which is incorporated herein by reference, are suitable for practice of the present invention. The CAM isozymes are the family of materials described by Alber et als at Biochemistry 1999, 38, 13119-13128 and further described by Alber and Ferry at Proceedings of the National Academy of Sciences of the United States of America, Volume 91, Issue 15 (Jul. 19, 1994), 6909-6913.

While these authors speculate that the isozymes will be more thermally stable they present no data regarding the use of these enzymes in a carbon dioxide capture system suitable for extracting carbon dioxide from a gas stream.

What is claimed is:

1. A process for gas separation wherein carbon dioxide in a mixed gas stream is converted to bicarbonate by contacting a gamma carbonic anhydrase enzyme designated as CAM in the temperature range of 40 degrees to 85 degrees C. in an enzyme catalyzed carbon dioxide capture system.
